(19) United States
(12) Patent Application Publication
(10) Pub. No.: US 2025/0196073 A1
(43) Pub. Date: Jun. 19, 2025

(54) GAS-MIXING DEVICE FOR CONTROLLED MIXING OF TWO DIFFERENT GASES

(71) Applicant: HOERBIGER FLOW CONTROL GMBH, Altenstadt (DE)

(72) Inventors: Daniel HALLER, Stuttgart (DE); Sebastian NEISS, Stuttgart (DE); Max SCHROBENHAUSER, Peiting (DE); Philipp STOLLBERG, Stuttgart (DE)

(21) Appl. No.: 19/065,714

(22) Filed: Feb. 27, 2025

Related U.S. Application Data
(63) Continuation of application No. PCT/EP2023/072698, filed on Aug. 17, 2023.

(30) Foreign Application Priority Data
Aug. 31, 2022 (DE) 10 2022 122 028.1

(51) Int. Cl. B01F 23/10; B01F 35/21; B01F 35/221; B01F 35/83

(52) U.S. Cl. CPC B01F 23/191; B01F 35/2113; B01F 35/2211; B01F 35/2213; B01F 35/833; B01F 2215/044

(57) ABSTRACT

A gas-mixing device is provided for the controlled mixing of two different gases. The gas-mixing device has a first inlet for a first gas which is under pressure, a second inlet for a second gas which is under pressure, and an outlet for the mixed gas. The gas-mixing device also has two gas-conducting lines. The first line connects the first inlet to the outlet, and the second line connects the second inlet to the outlet. In each line, an upstream valve, a proportional valve and a flow sensor are provided. The gas-mixing device additionally has at least one electronic control unit for controlling the two proportional valves and is designed such that the proportional valve of the first line acts as a pressure regulator and the proportional valve of the second line acts as a flow regulator.

### CROSS REFERENCE TO RELATED APPLICATIONS

This application is a continuation of International Application No.: PCT/EP2023/072698, filed Aug. 17, 2023, which claims priority to German Application No. 10 2022 122 028.1, filed Aug. 31, 2022, the contents of each of which are incorporated by reference herein.

### FIELD OF THE INVENTION

The present invention relates to a gas-mixing device for controlled mixing of two different gases, especially for mixing of two different gases at a high pressure of greater than 10 bar, wherein the gas-mixing device has a first input for a first gas maintained under pressure, a second input for a second gas maintained under pressure and one output for the mixed gas.

### BACKGROUND

For various technical applications, such as laser cutting, plasma cutting or plasma welding of metals in particular, it may be of advantage to carry out the respective process in a special atmosphere.

As an example, it is already known in this connection from the prior art according to EP 2 344 296 B1 that a machine for machining a workpiece by means of a laser beam, especially for laser cutting of metals, is provided with a gas-supply device with which gas from a gas source under high pressure is emitted by means of a gas nozzle in the region of the laser-machining unit of the machine, wherein the output pressure is adjusted by means of a specifically configured pressure-regulating valve.

Practice shows, however, that not only the choice of a particular gas and of a specific output pressure may be advantageous in the aforesaid applications, but that, especially in case of laser cutting, plasma cutting or welding, also the use of a gas mixture generated from two different gases and having a specific mixing ratio may entail additional improvements (for example, with respect to the cutting or welding quality and the maximum possible cutting or welding speed).

Typically, in such prior art, the desired gas mixture is generated in a first step at low pressure and retained in a buffer tank, which gas is then appropriately compressed to a high pressure for further use. However, this is associated with a relatively high equipment cost.

Furthermore, devices for mixing of gases at high pressures are also already known from the prior art, but they all likewise have a relatively complex construction and the gas mixture maintained under high pressure therein is likewise typically retained in a buffer tank.

Against this background, it is an object of the present invention to provide a gas-mixing device of the initially mentioned type having a relatively simple construction, at the output of which it is possible to supply a gas mixture from two different gases having high pressure and being adjustable in terms of the desired mixing ratio.

### SUMMARY

This object may be achieved by a gas-mixing device according to this disclosure. The following description, the drawings and the dependent claims explain advantageous aspects and configurations as well as preferred further developments of the present invention.

The gas-mixing device for controlled mixing of two different gases has a first input (or port) for a first gas maintained under (preferably high) pressure, a second input (or port) for a second gas maintained under (preferably high) pressure and one output for the mixed gas. It is also provided that the gas-mixing device has two gas-carrying branches, wherein the first branch connects the first input with the output and the second branch connects the second input with the output. A pilot valve, a proportional valve and a flow sensor are disposed in each of these branches. The gas-mixing device further has at least one electronic control unit for control of the two proportional valves and is set up in such a way that the proportional valve of the first branch functions as a pressure regulator and that the piezo-proportional valve of the second branch functions as a flow regulator.

Hereby, by using relatively simple means and parallel or simultaneous regulation of the two proportional valves in the different branches, it is possible to generate, at the output of the gas-mixing device, a gas stream-mixed together from two different gases-having constant output pressure, wherein simultaneously the gas-mixing ratio of the two gases is also precisely adjustable.

This is possible because the proportional valve of the first branch functions as a pressure regulator and the proportional valve of the second branch functions as a flow regulator. During operation of the proportional valve provided in the first branch as a pressure regulator, it is possible, in an expedient configuration of the invention, to regulate the pressure prevailing at the output of the proportional valve to a desired pressure. By virtue of the simultaneously occurring regulation of the gas flow by the proportional valve present in the second branch, for the regulation of which it is advantageously possible to use the measured values of the two flow sensors in both branches, what is then obtained at the output of the gas-mixing device—i.e., downstream from the junction of the two gas streams—is a defined output pressure at the output of the gas-mixing device and a defined mixing ratio of the two gases at the output of the gas-mixing device.

Obviously the pressure at the output of the gas-mixing device may in this case be adjusted or regulated only to such a value that is lower than the minimum of the two gas pressures supplied on the input side.

It then proves advantageous in the present situation that only one proportional valve operated as a flow regulator and one proportional valve operated as a pressure regulator are required in total and that, within the scope of the invention, no buffer tank is required for the mixed gas.

Thus the mixing ratio of the gases may be changed during operation of the gas-mixing device without having to blow, for this purpose, a gas mixture from a buffer tank in which it has already been retained and has a previously selected mixing ratio. In this respect, therefore, the device also permits particularly economical operation from the viewpoint of gas consumption during change of the mixing ratio of the gases to be mixed.

The flow sensors provided according to embodiments of the invention in each branch may be respectively any desired measuring device for determining the gas flow through the respective branch, wherein the flow sensors may be constructed, for example, as mass-flow or volume-flow sensors. In the further description it will be additionally explained that, during use of proportional valves with pressure sensors provided on the input and output sides, and given knowledge of the characteristics of the two proportional valves, the gas flow in each branch can also be determined by evaluation of the pressures measured on the input and output sides of the proportional valve in question, thus permitting a typically faster, albeit somewhat less precise measurement of the flows compared with the use of separate flow sensors. A flow sensor may therefore also be obtained by determining the flow (given knowledge of the characteristics of the proportional regulating valves) from pressures measured on the input and output sides of the proportional valve by means of pressure sensors provided there.

At the output of the gas-mixing device, it is possible if necessary to attach a pressure-regulating valve known from the prior art, with which the mixed gas is fed to a gas outlet (e.g., in the manner of a gas-exit nozzle), via which the mixed gas can be emitted, for example in the working area of a laser-cutting device, a plasma-cutting device or a welding device. If necessary, this pressure-regulating valve and the gas outlet connected downstream may if necessary also be part of the gas-mixing device.

The pilot valves provided in both branches of the gas-mixing device serve to prevent possible consumption of air or gas when the gas-mixing device is not active. Furthermore, a potential backflow of the respective gas into another line may be prevented with the pilot valves, inasmuch as this might be required from the viewpoint of circuit design. Within the scope of the present invention, operation of the pilot valves as pressure or flow regulators is neither necessary nor intended.

The pilot and proportional valves used in the gas-mixing device may in principle be of any desired design type, provided they are suitable for this in terms of their switching characteristic. In particular, for example, respectively a configuration as solenoid valves could be conceivable for this purpose.

In a particularly preferred configuration of the invention, the proportional valves provided in the two branches are respectively a piezo-proportional valve with a piezo-pneumatic preliminary stage and a pneumatic power stage actuated by this. Such piezo-proportional valves exhibit a switching behavior suitable for the present purpose and are sufficiently known from the prior art, wherein the preliminary stage of the piezo-proportional valve attached to a compressed-air supply typically contains an electrically actuatable piezo-bending transducer, with which the output of the pilot stage may be optionally pressurized with compressed air or vented. The power stage of the piezo-proportional valve connected downstream may then be actuated with the preliminary stage. The two pilot valves may also be advantageously configured as piezo-valves with piezo-pneumatic preliminary stage and a pneumatically actuated power stage.

In an expedient configuration of the invention it may be provided that the proportional valve (functioning as a pressure regulator) of the first branch is advantageously configured as a 3/3-way proportional valve, in which especially switched statuses may be adjusted for admitting air, for venting and for holding a particular pressure.

The proportional valve (functioning as flow regulator) of the second branch may preferably be configured as a 2/2-way proportional valve and is advantageously provided with an integrated actuating-sensor system for precise adjustment of a particular flowrate. Incidentally, an identical functionality may also be achieved by using a 3/3-way proportional valve in the second branch, provided one input of the valve is then appropriately deactivated and only two switched statuses can be established. Thus 3/3-way proportional valves of identical construction may also be used in the first and second branches of the gas-mixing device.

Furthermore, it may preferably be provided that the proportional valves of the first and second branches (respectively) have integrated pressure sensors, with which the pressure prevailing at the input and output sides of the respective proportional valve can be measured.

The measured values of these pressure sensors are then fed in an appropriate way (e.g., by means of a CAN bus) to the at least one electronic control unit, in order to take these measured data into consideration for generation of suitable regulating signals for the two proportional valves. The same is naturally applicable for the measured values of the two flow sensors provided in the two branches of the gas-mixing device.

Incidentally, it should be mentioned that the gas-mixing device may have either one single electronic control unit for simultaneous and parallel regulation of both proportional valves or that, for each proportional valve, respectively one separate electronic control unit is provided for regulation of the respective proportional valve, wherein regulation algorithms adequately known from the prior art may be used for the actual regulation of the two proportional valves. As an example, a PID regulator may be used for regulation of the mixing ratio. This regulator uses the measured flows of the two gases and from them calculates the current actual mixing ratio. From the resulting regulation deviation, the regulator determines a corresponding actuating signal for the flow-regulating valve. In an expedient further development of the present invention, and given knowledge of the characteristics of the two regulating valves, this regulator may additionally use the pressures measured at the input and output sides of both valves to achieve a typically faster, albeit less accurate measurement of the flows. These may be used if necessary (e.g., in case of rapid changes of the flows) instead of the measured values of the typically slower but more accurate flow sensors.

In order to improve the regulability of the system and to make the highest possible output pressure available, the gas-mixing device and the at least one control unit may advantageously be set up to determine, for the pressure at the output side of the pressure-regulating valve, from the pressure measured at the input side of the flow-regulating valve, an appropriate setpoint, which may be chosen, for example, to be 1 bar lower than the pressure at the input side of the flow-regulating valve. As an example, a PID regulator may then be used for pressure regulation proper. This regulator determines the regulation deviation from the pressure measured at the output side of the pressure-regulating valve and from the setpoint, and from that the actuating signal for the pressure-regulating valve. For improvement of the speed of regulation, this regulator may additionally use the pressure measured at the input side, in order, for example, to select various regulating parameters.

In the case of use of two separate electronic control units, it may also be provided if necessary that these are connected with one another in an appropriate way (e.g., by means of a CAN bus), whereby, for example, the measured data fed by individual pressure and flow sensors of a first of the two control units may also be delivered to the second of the two control units.

In an advantageous configuration of the invention, it may be further provided that the control unit of the gas-mixing device controlling the flow regulator is set up to determine the actual mixing ratio of the two gases from the measured values of the flow sensors provided in both branches.

Especially in the case of use of the gas-mixing device on a laser-cutting device, a plasma-cutting device or a welding device, it may preferably be provided that the first gas is nitrogen and the second gas is oxygen. In fact, for the aforesaid applications, the supplying of a gas mixture of oxygen and nitrogen maintained under high pressure and having a particular mixing ratio proves especially advantageous, because hereby the cutting or welding quality as well as the maximum possible cutting or welding speed may be positively influenced.

It may be expediently provided that each gas is supplied at the input assigned to it with a pressure of greater than 10 bar. For this purpose, the respective gas is typically supplied in a gas tank maintained under appropriate pressure and attached by means of appropriate high-pressure ports to the respective input of the gas-mixing device.

Furthermore, the gas-mixing device is advantageously set up to regulate the pressure of the mixed gas at the output of the gas-mixing device to a value of greater than or equal to 10 bar, preferably in the range between 15 and 40 bar or in the range between 15 and 30 bar.

Even further, it may be preferably provided within the scope of the invention that the first and second gases are brought to the output in a mixing ratio in which the first gas has a proportion between 80 and 99 vol.-% and the second gas has a proportion between 1 and 20 vol-%, wherein the sum of the two proportions obviously adds up to 100%.

And, finally, it proves to be particularly expedient when the gas-mixing device and the at least one control unit are set up such that, optionally, they can also be operated in an operating mode for conveying only one gas, wherein only one gas maintained under pressure is attached to one of the two inputs, while the branch connected with the other input is closed by means of the pilot valve therein and/or by means of the proportional regulating valve therein.

In this case, only the gas attached to an input then flows through the branch connected with the input in question in the direction of the output, whereas no gas flows in the other branch. Optionally, if a separate pressure-regulating valve is not yet connected downstream from the output, pressure regulation could then take place by means of the proportional regulating valve provided in the branch in question.

### BRIEF DESCRIPTION OF THE DRAWING

In the following, two exemplary embodiments of the invention will be explained in more detail on the basis of the drawing, wherein:

FIG. 1 shows a schematic circuit diagram of a first exemplary embodiment of an inventive gas-mixing device, and

FIG. 2 shows a likewise schematic but somewhat more detailed circuit diagram of a second exemplary embodiment of an inventive gas-mixing device.

### DETAILED DESCRIPTION OF THE PREFERRED EMBODIMENTS

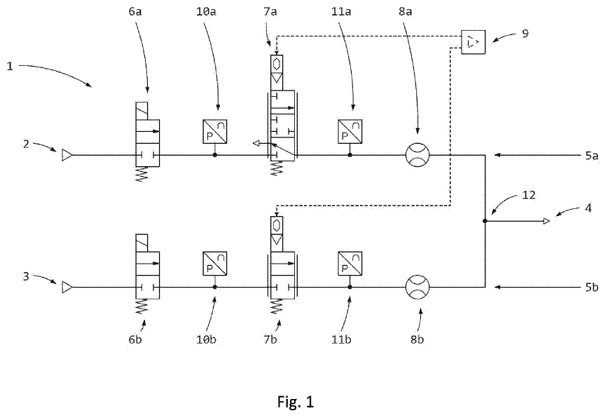

The first exemplary embodiment, illustrated in FIG. 1 in the form of a schematic circuit diagram, of a gas-mixing device 1 for controlled mixing of two different gases, has a first input 2 for a first gas maintained under pressure, a second input 3 for a second gas maintained under pressure and one output 4 for the mixed gas. Two gas-carrying branches 5a, 5b are provided in gas-mixing device 1, wherein first branch 5a connects first input 2 with output 4 and second branch 5b connects second input 3 with output 4.

Respectively one pilot valve 6a, 6b (for opening and closing the connection to the respectively assigned input 2, 3), one proportional valve 7a, 7b and one flow sensor 8a, 8b connected downstream from the proportional valve are disposed in each branch 5a, 5b, so that flow sensors 8a, 8b record the gas flow through the respective branch 5a, 5b in fluidic manner downstream from the respective proportional valve 7a, 7b.

Furthermore, for control of the two proportional valves 7a, 7b, an electronic control unit 9 is provided that is set up in such a way that proportional valve 7a of first branch 5a functions as a pressure regulator (for adjustment of a particular pressure at the output of proportional valve 7a present in first branch 5a) and that proportional valve 7b of second branch 5b functions as a flow regulator (for adjustment of a particular flowrate through proportional valve 7b present in second branch 5b).

By virtue of the parallel regulation of the two proportional valves 7a, 7b in the aforesaid sense, it is therefore possible simultaneously to regulate the pressure of the gas mixture at output 4 as well as the mixing ratio—which can be determined from the measured values of the two flow sensors 8a, 8b—of the two gases at output 4 to a particular value.

Each of the two proportional valves 7a, 7b in the two branches 5a, 5b is assigned respectively one pressure gauge 10a, 10b connected upstream in fluidic manner in the respective branch 5a, 5b and respectively one pressure gauge 11a, 11b connected downstream in fluidic manner in the respective branch 5a, 5b, with which gauges the pressures prevailing on the inlet and outlet sides of the respective proportional valves 7a, 7b can be determined. The measured values of the four pressure sensors 10a, 10b, 11a, 11b as well as the measured values of the two flow sensors 8a, 8b are delivered in an appropriate way to control unit 9, which for better clarity is not illustrated in FIG. 1.

The two branches 5a, 5b initially carrying one gas each are joined together in fluidic manner downstream from the respective flow sensor 8a, 8b at the position of reference symbol 12, so that a gas stream mixed from two different gases and having a defined mixing ratio and a defined pressure flows in the region between reference symbol 12 and output 4, in which the two branches 5a, 5b share the same fluid path.

With the exception of ports to be provided on the input and output sides, the gas-mixing device may be mounted completely or partly within a housing, not illustrated. As an example, output 4 for the mixed gas may then be formed by a port, which is provided on the housing of gas-mixing device 1 and to which a high-pressure line may be attached, which then leads, for example, to a laser-cutting device and at its other end has a gas-exit nozzle (or other gas outlet) for the mixed gas. In an alternative configuration of gas-mixing device 1, the junction of the two gas-carrying branches 5a, 5b in the region of reference symbol 12 may if necessary also be formed only outside the housing (e.g., in the region of the laser-cutting device). For this purpose, two ports, to which two high-pressure lines joined only outside the housing may be attached, are then to be provided appropriately on the output side of the housing.

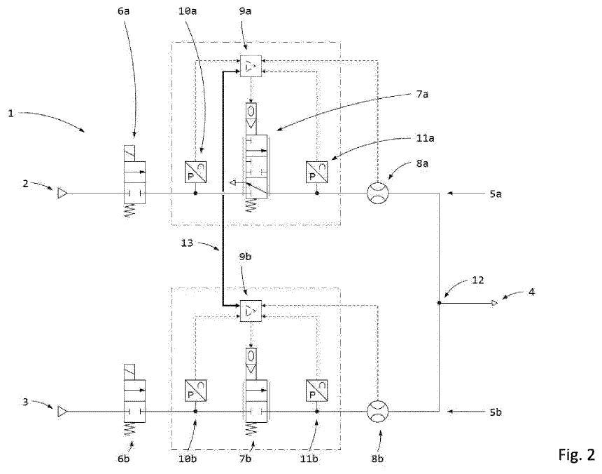

FIG. 2 shows a circuit diagram of a second exemplary embodiment of a gas-mixing device 1, in which identical reference symbols are used to denote like components.

In the second exemplary embodiment also, gas-mixing device 1 has two gas-carrying branches 5a, 5b, wherein first branch 5a connects input 2 for a first gas maintained under pressure with output 4 and second branch 5b connects input 3 for a second gas maintained under pressure with output 4.

Respectively one pilot valve 6a, 6b (for opening and closing the connection to the respectively assigned input 2, 3), one proportional valve 7a, 7b configured as a piezo-proportional valve and one flow sensor 8a, 8b connected downstream from the proportional valve are disposed in each branch 5a, 5b, so that flow sensors 8a, 8b record the gas flow through the respective branch 5a, 5b in fluidic manner downstream from the respective proportional valve 7a, 7b.

Flow sensors 8a, 8b provided in the two branches 5a, 5b are advantageously constructed as mass-flow sensors, because then the actual mixing ratio of the two gases upstream from gas junction 12 can be determined directly from the measured values of the two flow sensors. If flow sensors 8a, 8b are constructed as volume-flow sensors, which is likewise possible, the actual mixing ratio of the two gases may be calculated by additionally taking into consideration the gas pressures that are measured with pressure sensors 8a, 8b (connected downstream from the two proportional regulating valves 7a, 7b).

In the second exemplary embodiment, now no common electronic control unit but instead, for each (piezo-) proportional valve 7a, 7b, one separate electronic control unit 9a, 9b is provided for control of the respective proportional valve 7a, 7b, wherein the two control units 9a, 9b are set up in such a way that proportional valve 7a of first branch 5a is operated by means of first control unit 9a as a pressure regulator (for adjustment of a particular pressure at the output of proportional valve 7a present in first branch 5a) and that proportional valve 7b of second branch 5b is operated by means of second control unit 9b as a flow regulator (for adjustment of a particular flowrate through proportional valve 7b present in second branch 5b).

Each of the two proportional valves 7a, 7b in the two branches 5a, 5b has two integrated pressure gauges 10a, 11a and 10b, 11b, with which the pressures prevailing at the input and output sides of the respective proportional valves 7a, 7b can be determined. The measured values of pressure sensors 10a, 10b, 11a, 11b are fed directly to the control unit 9a, 9b assigned to the respective proportional valve 7a, 7b and, via the illustrated CAN bus 13, may also be exchanged between the two control units 9a, 9b. Furthermore, via the illustrated CAN bus 13, the measured values of the two flow sensors 8a, 8b may be delivered to both control units 9a, 9b.

In turn, the two branches 5a, 5b initially carrying one gas each are joined together in fluidic manner downstream from the respective flow sensor 8a, 8b at the position of reference symbol 12, so that a gas stream mixed from two different gases and having a defined mixing ratio and a defined pressure flows in the region between reference symbol 12 and output 4.

Initial investigations of the Applicant have shown that maximum pressures of 30 to 40 bar can be regulated with the gas-mixing device. In this way, and using two-stage piezo-pilot valves and two-stage piezo-proportional valves, it is possible to achieve regulator response times of shorter than 1 s at flowrates of up to 5,000 L/min and an output pressure in the range of approximately 20 bar.

What is claimed is:

1. A gas-mixing device (1) for controlled mixing of two different gases, especially for mixing of two different gases at a high pressure of greater than 10 bar, wherein the gas-mixing device (1) has a first input (2) for a first gas maintained under pressure, a second input (3) for a second gas maintained under pressure and one output (4) for the mixed gas, wherein:
the gas-mixing device (1) has two gas-carrying branches (5a, 5b),
wherein the first branch (5a) connects the first input (2) with the output (4) and the second branch (5b) connects the second input (3) with the output (4),
wherein a pilot valve (6a, 6b), a proportional valve (7a, 7b) and a flow sensor (8a, 8b) are disposed in each branch (5a, 5b), and
wherein the gas-mixing device (1) has at least one electronic control unit (9; 9a, 9b) for control of the two proportional valves (7a, 7b) and is set up in such a way that:
the proportional valve (7a) of the first branch (5a) functions as a pressure regulator and
the proportional valve (7b) of the second branch (5b) functions as a flow regulator.

2. The gas-mixing device of claim 1, wherein the proportional valves (7a, 7b) provided in the two branches (5a, 5b) are respectively a piezo-proportional valve with a piezo-pneumatic preliminary stage and a pneumatic power stage actuated by this.

3. The gas-mixing device of claim 1, wherein the proportional valve (7a) of the first branch (5a) is configured as a 3/3-way proportional valve.

4. The gas-mixing device of claim 1, wherein the proportional valve (7b) of the second branch (5b) is configured as a 2/2-way proportional valve.

5. The gas-mixing device of claim 1, wherein the proportional valves (7a, 7b) of the first and second branches (5a, 5b) have integrated pressure sensors (10a, 11a; 10b, 11b), with which the pressure prevailing at the input and output sides of the respective proportional-valve (7a, 7b) can be measured.

6. The gas-mixing device of claim 1, wherein the gas-mixing device (1) has either one single electronic control unit (9) for simultaneous and parallel regulation of both proportional valves (7a, 7b) or that, for each proportional valve (7a, 7b), respectively one separate electronic control unit (9a, 9b) is provided for regulation of the respective proportional valve (7a, 7b).

7. The gas-mixing device of claim 1, wherein the control unit (9; 9b) of the gas-mixing device (1) controlling the flow regulator is set up to determine the actual mixing ratio of the two gases from the measured values of the flow sensors (8a, 8b) provided in both branches.

8. The gas-mixing device of claim 1, wherein the first gas is nitrogen (N₂) and the second gas is oxygen (O₂).

9. The gas-mixing device of claim 1, wherein each gas is supplied at the input (2, 3) assigned to it with a pressure of greater than 10 bar.

10. The gas-mixing device of claim 9, wherein the gas-mixing device (1) is set up to regulate the pressure of the mixed gas at the output (4) of the gas-mixing device (1) to a value of greater than or equal to 10 bar, preferably in the range between 15 and 40 bar or in the range between 15 and 30 bar.

11. The gas-mixing device of claim 1, wherein the first and second gases are brought to the output (4) in a mixing ratio in which the first gas has a proportion between 80 and 99 vol.-% and the second gas has a proportion between 1 and 20 vol-%.

12. The gas-mixing device of claim 1, wherein the gas-mixing device (1) and the at least one control unit (9; 9a, 9b) are set up such that, optionally, they can also be operated in an operating mode for conveying only one gas, wherein only one gas maintained under pressure is attached to one of the two inputs, while the branch connected with the other input is closed by means of the pilot valve therein and/or by means of the proportional regulating valve therein.
